(19) United States
(12) Patent Application Publication
(10) Pub. No.: US 2012/0132502 A1
(43) Pub. Date: May 31, 2012

(54) Can transfer system

(76) Inventors: Tom Lawrence Thring, Cape Town (ZA); Cornelis Jacobus Molenaar, Paarl (ZA); Stefan Frisco Molenaar, Paarl (ZA)

(21) Appl. No.: 13/373,756

(22) Filed: Jan. 23, 2012

Related U.S. Application Data
(60) Provisional application No. 61/458,686, filed on Nov. 30, 2010.

(51) Int. Cl. B65G 29/00

(52) U.S. Cl. 198/480.1

(57) ABSTRACT

A system for transferring cans from a first rotary cooker or cooler to a second rotary cooker or cooler is provided. A smooth path is provided for transferring the cans to reduce denting and other damage to the cans. The cans can be transferred at higher speeds or with thinner walls. Acceleration imparted to the cans being transferred is minimized by using a slightly inclined discharge ramp, an upwardly concave tongue and a portion of the periphery of a support wheel between the discharge ramp and tongue.

### CROSS REFERENCE TO RELATED APPLICATION

This application claims the benefit of and priority from United States provisional application Ser. No. 61/458,686 filed Nov. 30, 2010.

### BACKGROUND

The present invention relates primarily to continuous rotary cooker-cooler (sterilizer) systems. Such systems are used to sterilize or cook metal cans which have been filled with food product and sealed. The vessels may be pressurized or atmospheric. (i.e. non-pressurized).

Rotary can cookers and coolers of conventional design are limited to speeds of around 400 cans per minute. Faster speeds result in can damage, particularly denting. This damage is often caused by impact loads resulting from acceleration and/or mechanical handling of the cans at those cans are transferred from a first rotary cooker or cooler to a second rotary cooker or cooler. The can damage problem has been identified as a limiting factor in running canning lines faster. The tendency towards 2-piece cans and thinner can material makes it even more important for the can transfer system to be can-friendly. What is needed in this art is a can transfer system that minimizes impact loads and accelerations applied to the cans being processed.

### BRIEF SUMMARY OF INVENTION

The present invention provides a can transfer system that allows rotary cooker-cooler systems to operate at speeds well above 400 cans per minute without increasing damage to the cans. The applicants have identified a significant problem with conventional can transfer systems for rotary cooker-coolers. The problem is that the prior art can transfer systems inherently apply accelerations to the cans being transferred from the cooker to the cooler, for example, that are great enough to cause unacceptable denting and other damage to cans at speeds higher than about 400 cans per minute. The present invention is an improved can transfer system that minimizes the accelerations imparted to the cans as they are discharged from a first rotary cooker or rotary cooler then fed into a second rotary cooker or rotary cooler. In one embodiment of the invention, a discharge ramp is positioned tangentially to the discharge end of the track of the rotary cooker. Cans discharged from the rotary cooker roll easily onto the tangential discharge ramp with little or no unwanted acceleration.

A support wheel is positioned adjacent the end of the discharge ramp. The cans roll off the end of the discharge ramp and roll across a portion of the periphery of the support wheel. The discharged cans then roll off the periphery of the support wheel onto a slightly concave tongue which is positioned between the rotary cooker and rotary cooler. As the cans roll across the tongue, they are subjected to a slight acceleration so that as the cans roll off the tongue, they are moving in a direction substantially parallel to and adjacent to the track of the rotary cooler. Almost all of the unwanted acceleration of the cans is thereby eliminated!! The cans can either be moved at much higher speeds or thinner metal can be used in the cans.

The can transfer system of this invention is used most commonly between a continuous rotary cooker and continuous rotary cooler. However, the system may also be used between two (or more) continuous rotary cookers, two (or more) continuous rotary coolers, and between a continuous rotary cooler and either a continuous rotary cooker or cooler. As used herein and in the claims, the phrase “rotary cooker” and the phrase “rotary cooler” refers to a single cylinder or shell.

A primary object of the invention is to provide a can transfer system for use with continuous rotary cookers and/or coolers which allows cans to be either transferred at higher speeds or made with thinner walls as compared with prior art systems.

A further object of the invention is to provide a can transfer system for use with continuous rotary cookers and/or coolers wherein the cans are subjected to significantly less acceleration as they are discharged from a first rotary cooker or cooler and as they are fed into a second rotary cooker or rotary cooler.

Another object is to provide a can transfer system with the above advantages and which may be retrofitted onto existing rotary cookers and rotary coolers.

Further objects and advantages will become apparent from the following description and drawings.

### BRIEF DESCRIPTION OF THE DRAWINGS

FIG. 1 is an illustration of a prior art can transfer system;

FIG. 2 is a schematic illustration of the concept of the can transfer system of the present invention;

FIG. 3 is another schematic illustration of the concept of the present invention;

FIG. 4 is a more detailed sectional view of the invention; and

FIG. 5 is a perspective view of a portion of the invention shown in FIG. 4.

### DETAILED DESCRIPTION OF THE DRAWINGS

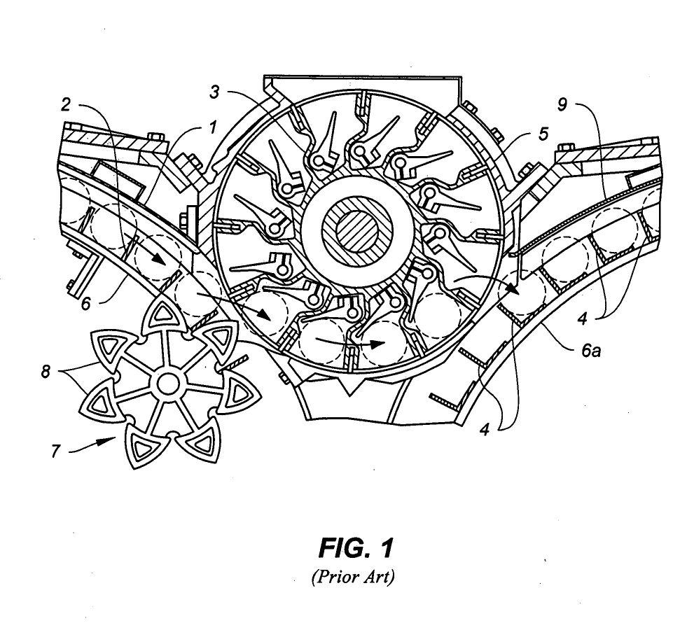

As shown in FIG. 1, a typical prior art can cooker/cooler set consists of a pair of horizontal cylindrical shells 1 and 9 with a diameter of approximately 2 m or more and a length of approximately 8 m or more. FIG. 1 shows the prior art transfer from shell 1 to shell 9. Each shell has internal spiral tracks or rails 6 and 6a. Cans are driven along the spiral track by L-brackets carried by a movable reel 2 (in shell 1) or 4 (in shell 9) rotating at approximately 10 rpm, so that cans spend perhaps 20 minutes in each shell. The shells, tracks and L-brackets are described more fully in U.S. Pat. No. 7,775,155, incorporated herein by reference. The spiral tracks are fixed and split to allow the reel to rotate between the split rails, as shown and described in the '155 patent.

Typically the shell is pressurized, but the present invention is applicable to both pressurized and atmospheric (non-pressurized) cookers and coolers which operate on similar principles. Seals in the transfer valve are not required if there is no pressure.

The prior art transfer valve rotor 3 is mechanically linked to the reels 2 and 4. In the case of pressurized systems, the rotor seals against the valve housing (mainly not shown), so that cans are momentarily in a sealed space before exiting to a different pressure area.

A typical prior art can transfer system is shown in FIG. 1. Cans at the end of their spiral path are driven by radially extending flat bars attached to the delivery end of the reel 2. At this point they are supported underneath by a static plate 6 and/or annular parts of the reel 2, the latter having a gap to avoid, interference with the ejector star 7. The ejector star 7 lifts the cans into the valve housing 5 through which they are carried by the rotor 3. Impact loads to the cans caused by the lobes 8 of the ejector star 7 result in much of the damage to the cans described above.

The cans driven by the prior art valve rotor 3 fall through an opening in the valve shell 5 onto the receiving reel 4 of the rotary cooler.

Impacts with various components during these, transfers in prior art systems cause unacceptable damage to cans at speeds of above about 400 cans per minute.

What is needed in this art is a transfer system that minimizes impact loads and accelerations applied to the cans being transferred. Such an advance has been achieved by the present invention. The present invention allows higher canning speeds to be achieved and/or thinner walled cans to be utilized, all without increased rates of damage to the cans. The invention can be retrofitted onto existing rotary cookers and coolers.

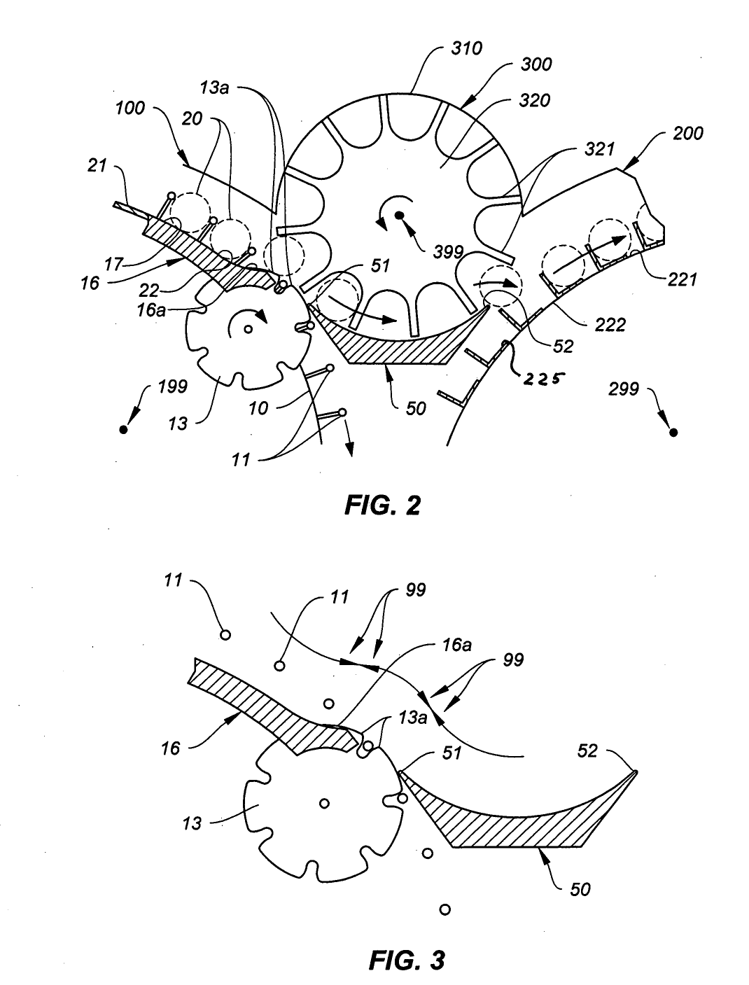

The novel mechanism is shown in “concept” FIGS. 2 and 3 below, where transfer is shown and described below.

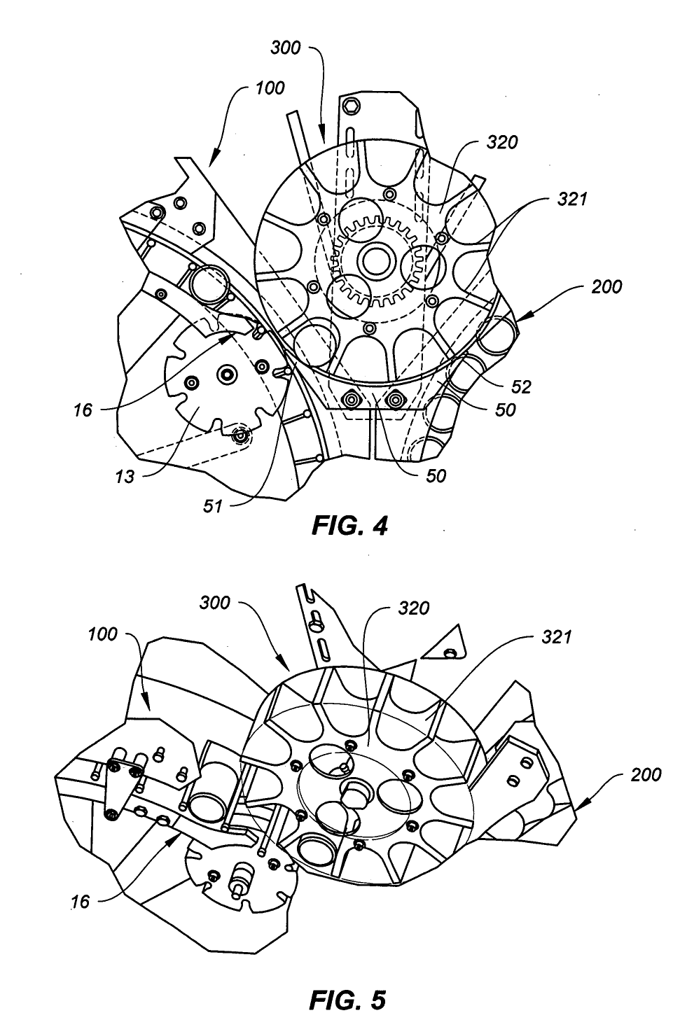

FIGS. 2 and 4 illustrate a common use of the invention, i.e. transferring cans from a continuous rotary cooker 100 to a continuous rotary cooler 200. It is to be understood that the invention can also be utilized to transfer cans between two rotary cookers or two coolers, and also from a cooler to a cooker.

The cans 20 travel along a first stationary and spiral track 21 driven by the rotating reel 10, which carries pins 11. The cans 20 are driven by the pins 11 which are part of the reel 10. Track 21 is a fixed split rail track, allowing reel 10 to rotate between the fixed rails.

As the cans approach the discharge end 22 of first spiral track 21, a discharge ramp 16 with a surface 16a smoothly lifts the cans 20. Discharge ramp 16 has a surface 17 which is positioned substantially tangential to a portion 13a of the periphery of support wheel 13. Support wheel 13 is positioned adjacent the discharge end 22 of first spiral track 21. The phrase “substantially tangential to” means forming an angle between 0° and 10° between the two surfaces. The discharge ramp 16 has a smooth, slightly inclined surface that extends outwardly relative to the center 199 of rotary cooker 100. The phase “slightly inclined surface” means having an incline between 0° and 10° relative to the surface of the discharge end 16a of ramp 16. The tongue 50 is upwardly concave. The phrase “upwardly concave” means having a center or curvature above said tongue, and wherein the total curvature of said tongue 50 is between 20° and 60° over its length. The surface of first end 51 of tongue 50 is aligned with the portion 13a of the arcuate periphery of support wheel 13. The phase “aligned with” means the two surfaces form an angle less than 5°. The second end 52 of tongue 50 is adjacent to and parallel with the surface of the input end 222 of second spiral track 221. The cans 20 drop a small distance onto track 221 and are moved by reel 225. The ramp 16 is slotted to avoid interference with the support wheel 13, so the cans are supported briefly on the outside diameter or periphery 13a of the support wheel 13. With a prior art ejector star wheel 7 of FIG. 1 by contrast, the cans are lifted by a relatively strong impact with the flank of its lobes. The support wheel 13 is narrower than the height of the cans, so the cans are supported on their middles for a short time. It should be noted that the trajectory of the cans as they move from the ramp to the support wheel 13 is virtually tangent to the periphery 13a of support wheel and therefore the force of the support wheel on the body of the can is very small or zero.

When the cans are clear of the path of the pins 11, they slide or roll onto an upwardly concave tongue 50. The tongue 50 is fixed to the housing 310 of rotary transfer valve means 300, and is slotted to avoid interference with the support wheel 13, so the cans are initially supported on their ends on the tongue 50. The cans continue into the valve housing 310 where they are driven by the valve rotor 320. Valve rotor 320 has a plurality of arcuate recesses 321 formed around its periphery. The recesses receive the cans and maintain the proper spacing between cans as the rotor rotates and moves the cans along discharge ramp 16, across tongue 50, and onto the input end 222 of the second spiral track 221 of cooler 200.

Rotary cooker (or cooler) 100, rotary cooker or cooler 200 and rotary transfer valve means rotate around parallel spaced apart longitudinal axes 199, 299, and 399, respectively. Spiral tracks 21 and 221 form helical paths around axes 199 and 299 respectively.

Unlike with conventional transfer systems, the cans are supported throughout the transfer, and are never allowed to fall a significant distance. Also, no sudden changes of direction are experienced by the cans, since the system is designed so that the can path consists of a series of arcs and lines with consecutively tangent ends as shown by arrows 99 in FIG. 3.

FIG. 3 shows the sequence of support for each can. Initially the can is supported on the discharge ramp 16, then it transfers smoothly to the periphery of support wheel 13, and then to the tongue 50 along a gently curved path shown by arrows 99.

FIGS. 4 and 5 are more detailed drawings of the “concept” shown in FIG. 2. The reference numerals of FIGS. 4 and 5 correspond to those used in FIG. 2.

FIGS. 2-5 illustrate an embodiment wherein support wheel 13 is the drive wheel of a prior art ejector 7 as shown in FIG. 1 with the lobes 8 removed. The embodiment shown in FIGS. 2-5 may be easily retrofitted onto existing rotary cookers or coolers having an ejector 7 by simply removing the lobes of the prior art ejector 7.

### Differences From Prior Art

1. The cans are accelerated upward by a static discharge ramp 16, minimizing acceleration of the cans and impact loads caused by prior art devices.

2. The cans do not strike the sides of the lobes of an ejector wheel, which cause an abrupt change of direction and related impact loads.

3. The cans are supported on the outside diameter of the wheel 13.

4. The discharge ramp 16 is cut away along its longitudinal center line to clear the wheel 13, so there is a smooth transfer from the discharge ramp to the wheel 13 (there is a slot on the ramp to clear the wheel—could be vice versa).

5. The tongue 50 is cut away to clear the wheel 13 so there is a smooth transfer from the wheel to the tongue 50 (there is a slot on the tongue to clear the wheel—could be vice versa).

6. The cans are supported throughout the transfer, and are never allowed to fall a significant distance.

7. No sudden changes of direction are experienced by the cans.

The foregoing description of the invention has been presented for purposes of illustration and description and is not intended to be exhaustive or to limit the invention to the precise form disclosed. Modifications and variations are possible in light of the above teaching. The embodiments were chosen and described to best explain the principles of the invention and its practical application to thereby enable others skilled in the art to best use the invention in various embodiments and with various modifications suited to the particular use contemplated.

What is claimed is:

1) Apparatus for transferring cans between a first continuous rotary cooker or rotary cooler and a second continuous rotary cooker or rotary cooler wherein said first rotary cooker or rotary cooler has a first spiral track having a surface on which cans are moved through said first rotary cooker or cooler, wherein said first spiral track has a discharge end, wherein said first rotary cooker or cooler has a support wheel adjacent said discharge end of said first spiral track, wherein said support wheel has a periphery, wherein said second rotary cooker or cooler has a second spiral track having a surface on which cans are moved through said second rotary cooker or rotary cooler, and wherein said second spiral track has an input end, comprising:
a discharge ramp positioned substantially tangential to the surface of the discharge end of said first spiral track of said first rotary cooker or rotary cooler, said discharge ramp having a smooth, slightly inclined surface that extends outwardly relative to the center of said first rotary cooker or cooler, said ramp having a discharge end,
an upwardly concave tongue positioned between said first and second rotary cooker or rotary cooler, said tongue having an upper surface, said upper surface of said first end of said tongue being aligned with said periphery of said support wheel, and wherein said tongue has a second end positioned adjacent said input end of said second spiral track in said second rotary cooker or cooler, and
wherein said support wheel has a segment of its periphery that forms a smooth, curved surface between said discharge end of said discharge ramp and said upper surface of said first end of said tongue.

2) The apparatus of claim 1 further comprising a rotary transfer valve means positioned above said discharge ramp and said tongue and between said first rotary cooker or cooler and said second rotary cooker or cooler for transferring cans discharged from said first rotary cooker or cooler to said second rotary cooker or cooler, said rotary transfer valve means having a plurality of recesses around its periphery for receiving cans discharged from said first rotary cooker or cooler, moving said cans along said discharge ramp and along said tongue, and transferring said cans onto said input end of said second spiral track in said second rotary cooker or cooler.

3) The apparatus of claim 2 wherein said first and second spiral tracks extend around parallel, spaced apart longitudinal central axes of said first rotary cooker or cooler and said second rotary cooker or rotary cooler, and wherein said transfer valve means rotates around an axis parallel with, and spaced apart from, said longitudinal central axes of said first rotary cooker or cooler and said rotary cooker or cooler.

4) Apparatus for transferring cans between a continuous rotary cooker and a continuous rotary cooler wherein said rotary cooker has a first spiral track having a surface on which cans are moved through said rotary cooker, wherein said first spiral track has a discharge end, wherein said rotary cooler has a second spiral track having a surface on which cans are moved through said rotary cooler, and wherein said second spiral track has an input end, comprising:
a discharge ramp having a surface positioned substantially tangential to the surface of said discharge end of said first spiral track, wherein said discharge ramp has a smooth, slightly inclined surface that extends outwardly relative to the center of said rotary cooker, said ramp having a discharge end,
an upwardly concave tongue positioned between said rotary cooker and said rotary cooler, said tongue having a first end positioned adjacent said discharge end of said discharge ramp, said tongue having an upper surface, said upper surface of said first end of said tongue being aligned with said upper surface of said discharge end of said discharge ramp, and wherein said tongue has a second end positioned adjacent said input end of said second spiral track.
